(19) United States
(12) Patent Application Publication
(10) Pub. No.: US 2018/0247219 A1
(43) Pub. Date: Aug. 30, 2018

(54) LEARNING APPARATUS CONFIGURED TO PERFORM ACCELERATED LEARNING, A METHOD AND A NON-TRANSITORY COMPUTER READABLE MEDIUM CONFIGURED TO PERFORM SAME

(71) Applicant: Alcatel-Lucent USA Inc., Murray Hill, NJ (US)

(72) Inventors: Lawrence O'GORMAN, Madison, NJ (US); Roger LEVY, Berkeley Heights, NJ (US); Xiaoyang WANG, Murray Hill, NJ (US)

(21) Appl. No.: 15/443,136

(22) Filed: Feb. 27, 2017

(51) Int. Cl. G06N 99/00

(52) U.S. Cl. CPC G06N 99/005

(57) ABSTRACT

In at least some example embodiments, a learning apparatus may include a processor configured to capture one or more parallel samples of a feature at a regular interval, selectively perform accelerated learning of a trend based on a number of the one or more parallel samples, and analyze a latest parallel sample of the one or more parallel samples based on the trend, where the accelerated learning may include capturing augmented samples.

### BACKGROUND

### 1. Field

Example embodiments relate generally to a learning apparatus configured to perform accelerated learning, a method, and/or a non-transitory computer readable medium configured to perform same.

### 2. Related Art

A statistical learning system may be used to improve automatic detection of events by continually learning by improving various criteria utilized by the statistical learning system based on, for example, samples collected by the statistical learning system. For example, video surveillance systems may learn a trend of normal activity for the purpose of subsequently detecting anomalous activity that deviates from this trend.

However, due to various factors, such as weekends, holidays, weather, etc., a threshold for activity that is considered anomalous may vary, for example, over hours, days, weeks, months, seasons, etc. Therefore, a conventional learning system may require a relatively long period of time before enough samples have been collected for the conventional learning system to accurately detect the anomalous activity.

This delay may cause the conventional learning system to be unusable until the conventional learning system collects a sufficient amount of sample data, and, thus a user and/or a potential purchaser of the conventional statistical learning system at, for example, a trade show or during an evaluation period, may be dissatisfied with the initial performance of the conventional learning system.

### SUMMARY

At least some example embodiments relate to a learning apparatus.

In some example embodiments, the learning apparatus includes a processor configured to, capture one or more parallel samples of a feature, the one or more parallel samples being samples captured at a regular interval, selectively perform accelerated learning of a trend based on a number of the one or more parallel samples, and analyze a latest parallel sample of the one or more parallel samples based on the trend.

In some example embodiments, the processor is configured to selectively perform the accelerated learning by, determining whether the learning apparatus is operating in an accelerated learning state or a normal learning state based on the number of the one or more parallel samples and a threshold, and if the learning apparatus is operating in the accelerated learning state, capturing one or more augmented samples related to the latest parallel sample, and updating the trend based on a set of samples from the one or more augmented samples and the one or more parallel samples.

In some example embodiments, the processor is configured to determine the threshold based on the trend and a statistical variance of the one or more parallel samples.

In some example embodiments, the processor is configured to determine whether the learning apparatus is in a transition period based on whether a transition time constant and a desired time constant converge, if the learning apparatus is operating in the normal learning state.

In some example embodiments, the processor is configured to, update the trend by transitioning from an arithmetic mean of the set of samples to a moving average of the set of samples based on the transition time constant, if the learning apparatus is in the transition period, and update the trend based on a moving average of the one or more parallel samples, if the learning apparatus has completed the transition period.

In some example embodiments, the processor is further configured to capture the one or more parallel samples from a first source device such that the one or more parallel samples are obtained at multiples of the interval.

In some example embodiments, the processor is further configured to capture the one or more augmented samples by, capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.

In some example embodiments, the processor is configured to analyze the latest parallel sample by determining whether a mathematical relationship between the latest parallel sample and the trend meets a criteria.

In some example embodiments, the processor is further configured to selectively perform an action, if the mathematical relationship meets the criteria.

Some example embodiments relate to a method of operating a learning apparatus.

In some example embodiments, the method includes capturing one or more parallel samples of a feature, the one or more parallel samples being samples captured at a regular interval; selectively performing accelerated learning of a trend based on a number of the one or more parallel samples; and analyzing a latest parallel sample of the one or more parallel samples based on the trend.

In some example embodiments, the selectively performing accelerated learning includes determining whether the learning apparatus is operating in an accelerated learning state or a normal learning state based on the number of the one or more parallel samples and a threshold; and if the learning apparatus is operating in the accelerated learning state, capturing one or more augmented samples related to the latest parallel sample, and updating the trend based on a set of samples from the one or more augmented samples and the one or more parallel samples.

In some example embodiments, the method further includes determining the threshold based on the trend and a statistical variance of the one or more parallel samples.

In some example embodiments, the method further includes determining whether the learning apparatus is in a transition period based on whether a transition time constant and a desired time constant converge, if the learning apparatus is operating in the normal learning state; updating the trend by transitioning from an arithmetic mean of the set of samples to a moving average of the set of samples based on the transition time constant, if the learning apparatus is in the transition period; and updating the trend based on a moving average of the one or more parallel samples, if the learning apparatus has completed the transition period.

In some example embodiments, the capturing the one or more parallel samples captures the one or more parallel samples from a first source device such that the one or more parallel samples are obtained at multiples of the interval, and the capturing one or more augmented samples includes capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.

In some example embodiments, the analyzing includes determining whether a mathematical relationship between the latest parallel sample and the trend meets a criteria, and the method further includes selectively performing an action, if the mathematical relationship meets the criteria.

Some example embodiments relate to a non-transitory computer readable medium storing instructions that, when executed by a processor, configure the processor to operate a learning apparatus.

In some example embodiments, the instructions, when executed, configure the processor to capture one or more parallel samples of a feature, the one or more parallel samples being samples captured at a regular interval; selectively perform accelerated learning of a trend based on a number of the one or more parallel samples; and analyze a latest parallel sample of the one or more parallel samples based on the trend.

In some example embodiments, the instructions, when executed, configure the processor to selectively perform accelerated learning by, determining whether the learning apparatus is operating in an accelerated learning state or a normal learning state based on the number of the one or more parallel samples and a threshold; and if the learning apparatus is operating in the accelerated learning state, capturing one or more augmented samples related to the latest parallel sample, and updating the trend based on a set of samples from the one or more augmented samples and the one or more parallel samples.

In some example embodiments, the instructions, when executed, configure the processor to determine the threshold based on the trend and a statistical variance of the one or more parallel samples.

In some example embodiments, the instructions, when executed, configure the processor to determine whether the learning apparatus is in a transition period based on whether a transition time constant and a desired time constant coverage, if the learning apparatus is operating in the normal learning state, update the trend by transitioning from an arithmetic mean of the set of samples to a moving average of the set of samples based on the transition time constant, if the learning apparatus is in the transition period, and update the trend based on a moving average of the one or more parallel samples, if the learning apparatus has completed the transition period.

In some example embodiments, the instructions, when executed, configure the processor to capture the one or more parallel samples from a first source device such that the one or more parallel samples are obtained at multiples of the interval, and capture the one or more augmented samples by capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.

### BRIEF DESCRIPTION OF THE DRAWINGS

At least some example embodiments will become more fully understood from the detailed description provided below and the accompanying drawings, wherein like elements are represented by like reference numerals, which are given by way of illustration only and thus are not limiting of example embodiments and wherein:

FIG. 1 illustrates a flowchart of conventional learning executed by a conventional learning apparatus;

FIG. 2 illustrates a learning system according to example embodiments;

FIG. 3 is a block diagram illustrating a learning apparatus included in a learning system according to an example embodiment;

FIG. 4 illustrates a flowchart of a method of operating a learning apparatus according to an example embodiment;

FIG. 5 illustrates a flowchart of a method of accelerated learning executed by a learning apparatus according to an example embodiment;

FIG. 6 illustrates a flowchart of an operation of updating a trend by a learning apparatus according to an example embodiment;

FIG. 7 illustrates a flowchart of an operation of generating and combining augmented samples according to an example embodiment;

FIG. 8 illustrates an example of utilizing sequential time samples to augment parallel time samples according to an example embodiment;

FIG. 9 illustrates an example of utilizing collapsed time samples to augment parallel time samples according to an example embodiment; and

FIG. 10 illustrates an example of utilizing multi-view time samples to augment parallel time samples according to an example embodiment.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing at least some example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments are discussed herein as being implemented in a suitable computing environment. Although not required, example embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware. Such existing hardware may include one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof at, for example, hosts, computers, cloud computing based servers accessible via a network, web servers, etc. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

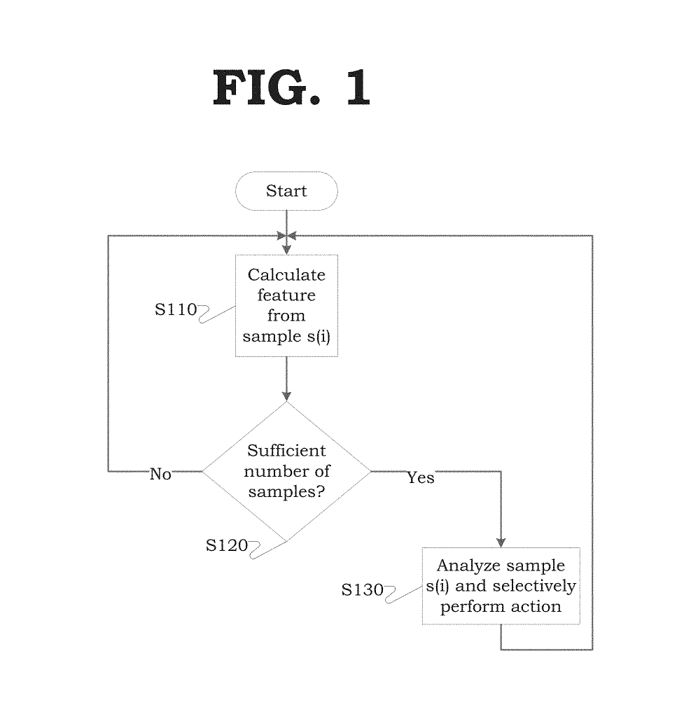

FIG. 1 illustrates a flowchart of conventional learning executed by a conventional learning apparatus according to example embodiments.

Referring to FIG. 1 in operation S110, the learning apparatus may calculate a feature from a sample s(i), where the sample is associated with a discrete time i.

This sample s(i) can be a raw sample from a capture device such that the sample contains a number that represents some physical measurement, such as a pixel from a camera or a temperature reading from a digital thermometer. The learning apparatus may calculate a feature from the raw sample.

For example, in a video analytics application, various ones of the following motion features may be extracted from the sample s(i) of video:
density—fraction of motion samples per total samples in a block (region);
direction—average direction of motion in a block;
velocity—average velocity in a block; and/or
dwell—fraction of “static motion” samples per total samples in a block, where “static motion” is defined as samples that formerly had motion, but are temporarily stopped.

The learning apparatus may utilize previously collected samples S(i)=f(s(i)), i=1 to N′ to analyze the sample s(i), where N′ is the number of samples s(i) collected by the learning apparatus, and S(i) is a value calculated by performing a function f( ), such as averaging, on each sample s(i).

In operation S120, the conventional learning apparatus may determine whether the number N′ of samples S(i) collected up to time i is sufficient to analyze the sample s(i).

However, in a conventional learning apparatus, when the conventional learning apparatus is in an initialization phase, the conventional learning apparatus may not have enough samples S(i) collected to accurately analyze the sample s(i) because the number of samples N′ may be insufficient to determine with a high level of statistical confidence a base line due to deviations amongst the collected samples S(i).

Therefore, as illustrated in FIG. 1, the conventional learning apparatus may refrain from performing analysis on the sample s(i) until the number of collected samples N′ equals a minimum sample size N.

The conventional learning apparatus may determine the sufficient number samples N utilizing a statistical confidence perspective (for Gaussian-distributed data) as described in Equation 1:

N′=Z**2*d*(1−d)/e**2 Eq. 1

In Equation 1, N may represent the minimum sample size for a Z-score corresponding to a chosen confidence level, d may represent the estimated standard deviation, and e may represent the allowed margin of error.

For instance, if the confidence level is 95%, (Z=1.96), an estimated and normalized standard deviation is d=0.5, and the allowed margin of error is e=+/−10%, the learning apparatus 100 may utilize Equation 1 to determine that the minimum sample size N=1.96*1.96*0.5*0.5/0.1**2=96 samples.

In practice, each sample s(i) should be representative of the samples S(i) to estimate. Say, for example, estimates are made only upon samples taken hourly during an 8-hour business day. In this case, the 96 samples would require 96/8=12 business days to collect. So, for the confidence level having a standard deviation of d=95%, the conventional learning apparatus may take 12 business days to collect enough data before that data is used to make decisions. This long learning duration may be inconvenient or unacceptable in some applications.

In many cases, a collective of samples that has similarly representative characteristics occur with some regularity, such as every D time units. For example, the sample s(i) captured at i=10:00 am Monday may have similar characteristics to corresponding sample values captured on previous Mondays at 10:00 am. In this case, the interval is 1 day (or 24 hours, or 24*60 minutes, etc.) depending upon the time unit. These parallel time samples may be represented by Equation 2:

p(i)=s(i−nD),0<i<N0,1<n<N0 Eq. 2

In Equation 2, D may represent the interval between the parallel samples p(i),

In operation S130, if the number N′ of samples S(i) obtained by the conventional learning apparatus is at least the minimum sample size N, the conventional learning apparatus may analyze the sample s(i) and selectively perform various actions based on a result of the analysis.

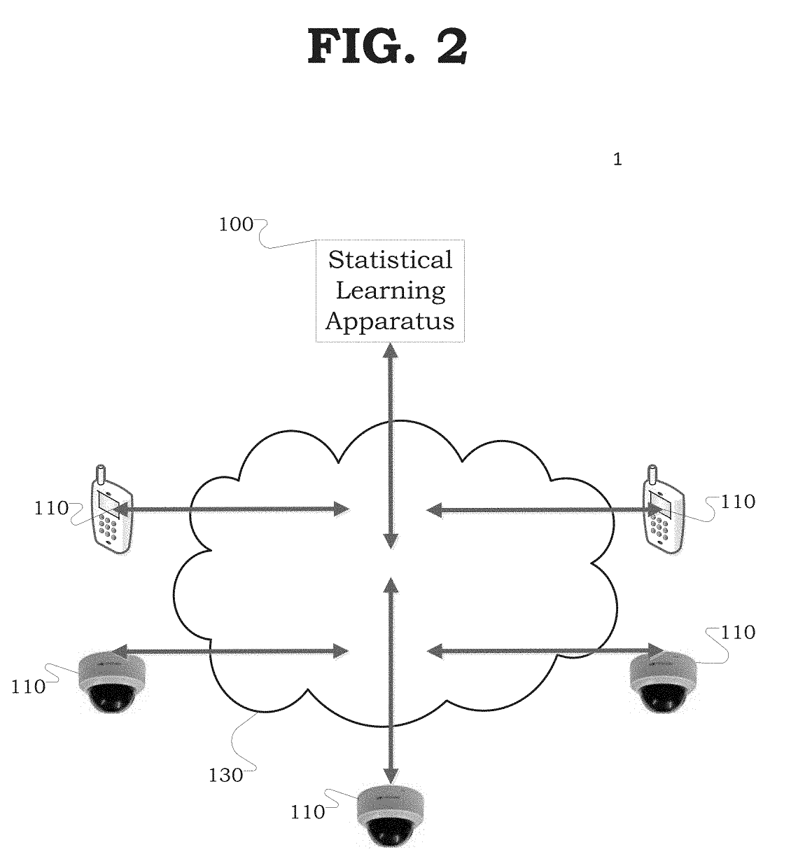

FIG. 2 illustrates a learning system according to an example embodiment.

Referring to FIG. 2, a learning system 1 may include a learning apparatus 100 connected to one or more source devices 110 over a network 130.

As discussed in more detail below, the learning apparatus 100 may be configured to expedite a learning process by collecting augmented samples S′(i) in addition to the obtained parallel samples p(i) in a faster time than it would take to learn based on only the parallel samples p(i) obtained at the same interval D. Therefore, the learning apparatus 100 may reduce the length of time before the learning apparatus 100 is able to accurately detect anomalous activity.

The one or more source devices 110 may be various devices that stream data (e.g., audio and/or video data, or other forms of data), such as internet protocol (IP) cameras, smart phones, digital video records (DVRs), or various Internet of Things (IoT) devices, for example, infrared imagers, temperature sensors, air quality sensors, radiation sensors, ultrasound sensors, pressure sensors, etc. However, example embodiments are not limited thereto. For example, the one or more source devices 110 may be any device capable of streaming data via a connection between the respective one of the one or more source devices 110 and the learning apparatus 100. In some example embodiments, the one or more source devices 110 and the learning apparatus 100 may perform machine-to-machine (M2M) communication via the network 130 without human intervention.

The network 130 may be any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like.

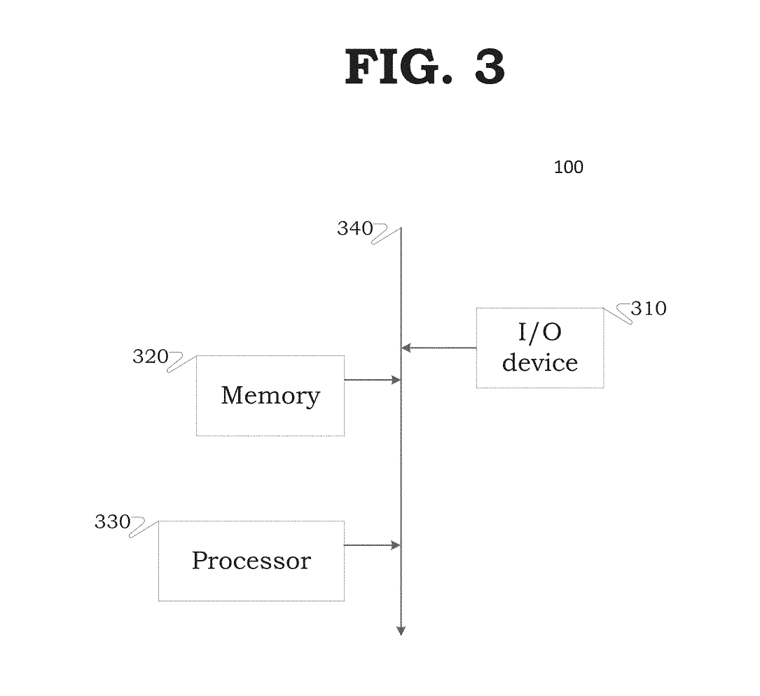

FIG. 3 is a block diagram illustrating a learning apparatus according to an example embodiment.

Referring to FIG. 3, the learning apparatus 100 may include (I/O) device 310, a memory 320, processing circuitry 330 and a bus 340.

The I/O device 310 included in the data processing apparatus 100 may include various interfaces including one or more transmitters/receivers (or transceivers) connected one or more antennas or wires to transmit/receive control and data signals.

The transmitters may be devices that include hardware and software for transmitting signals including, for example, control signals or data signals via one or more wired and/or wireless connections to other network elements over the network 130. Likewise, the receivers may be devices that include hardware and software for receiving wireless signals including, for example, control signals or data signals via one or more wired and/or wireless connections to other network elements over the network 130.

The memory 320 may be a computer readable storage medium that generally includes a random access memory (RAM), read only memory (ROM), and/or a permanent mass storage device, such as a disk drive. The memory 320 also stores an operating system and any other routines/modules/applications for providing the functionalities of the data processing apparatus 100. These software components may also be loaded from a separate computer readable storage medium into the memory 320 using a drive mechanism (not shown). Such separate computer readable storage medium may include a disc, tape, DVD/CD-ROM drive, memory card, or other like computer readable storage medium (not shown). In some example embodiments, software components may be loaded into the memory 320 via one or more interfaces (not shown), rather than via a computer readable storage medium.

The processing circuitry 330 may be, but not limited to, a processor, Central Processing Unit (CPU), a controller, an arithmetic logic unit (ALU), a digital signal processor, a microcomputer, a field programmable gate array (FPGA), an Application Specific Integrated Circuit (ASIC), a System-on-Chip (SoC), a programmable logic unit, a microprocessor, or any other device capable of performing operations in a defined manner.

The processing circuitry 330 may be configured, through a layout design and/or execution of computer readable instructions stored in the memory 320, as a special purpose computer to accelerate a learning procedure of the learning apparatus 100. Therefore, the processing circuitry 330 may improve the functioning of the learning apparatus 100 itself, by reducing the length of time before the learning apparatus 100 is able to accurately detect anomalous activity.

As will be appreciated, depending on implementation, the learning apparatus 100 may include additional components other than those shown in FIG. 3. However, it is not necessary that all of these components be shown in order to convey illustrative example embodiments to persons having ordinary skill in the art.

Further, in some example embodiments, the learning apparatus 100 may be implemented via cloud computing such that one or more of the memory 320 and processing circuitry 330 are performed by functional equivalent cloud-based abstractions.

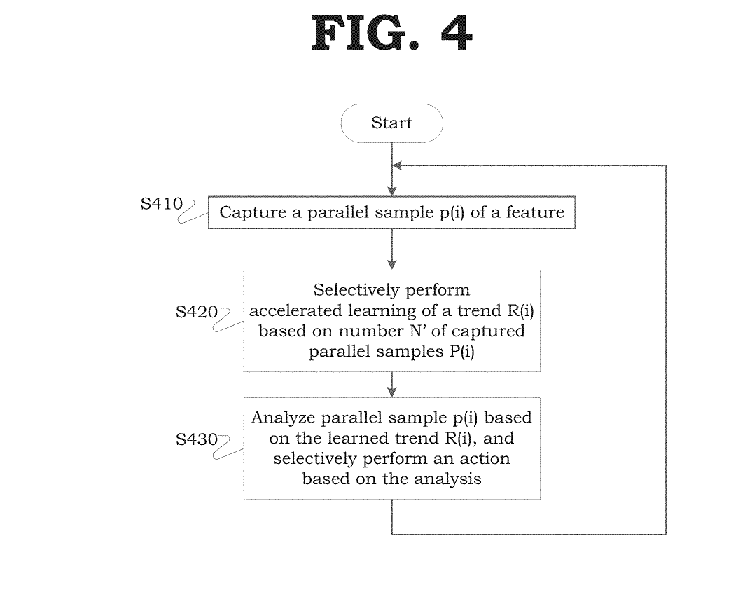

FIG. 4 illustrates a flowchart of a method of operating a learning apparatus according to example embodiments.

Referring to FIG. 4, in operation S410, the learning apparatus 100 may capture a sample s(i) associated with the discrete time i.

For example, the learning apparatus 100 may capture the sample s(i) at discrete instances of a fixed interval D such that the sample s(i) is the parallel sample p(i), as defined in Equation 2, discussed supra, and the learning apparatus 100 performs operation S410 at each instance of the interval D.

In operation S420, the learning apparatus 100 may selectively perform accelerated learning of a trend R(i) based on the number N′ of captured parallel samples P(i). The trend R(i) may represent an average or expected value of the parallel sample p(i).

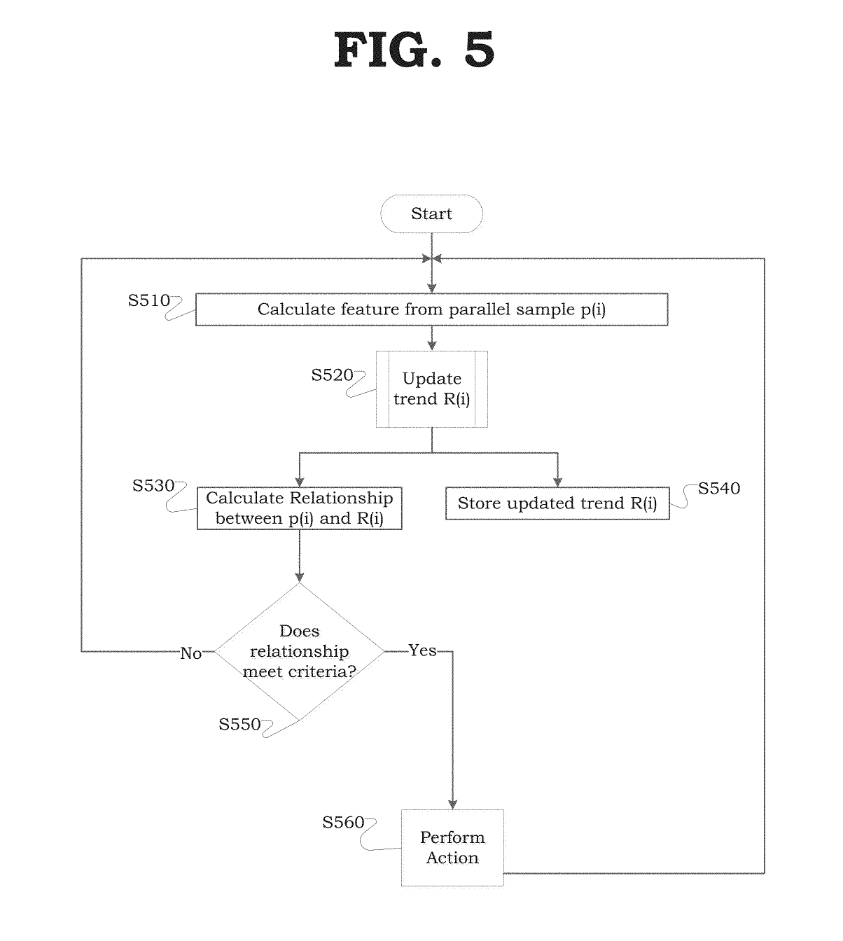

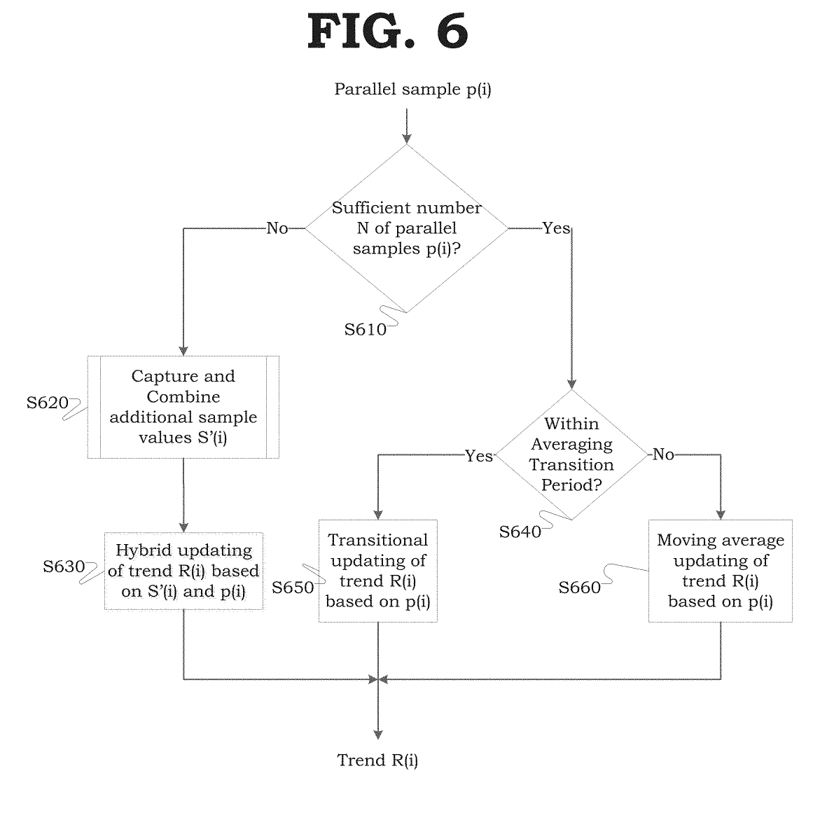

However, unlike a conventional learning apparatus, and as discussed in more detail below with reference to FIGS. 5 and 6, the learning apparatus 100 may update the trend R(i) through an accelerated learning procedure using both the parallel sample p(i) and an augmented sample S′(i).

In operation S430, the learning apparatus 100 may analyze the parallel sample p(i) based on the learned trend R(i), and selectively perform an action based on the analysis.

FIG. 5 illustrates a flowchart of a method of accelerated learning executed by a learning apparatus according to an example embodiment.

Referring to FIGS. 4 and 5, as discussed in more detail below, operation S410, illustrated in FIG. 4, may correspond to operation S510. Further, operation S420, illustrated in FIG. 4, may correspond to operations S520 and S540, and operation S430, illustrated in FIG. 4, may correspond to operations S530 to S560.

In operation S510, the learning apparatus 100 may capture a sample s(i) associated with the discrete time i.

As discussed above, in the video analytics application, the learning apparatus 100 may use the raw sample as is, or the learning apparatus 100 may calculate one of the following features from the parallel sample p(i):
density—fraction of motion samples per total samples in a block (region);
direction—average direction of motion in a block;
velocity—average velocity in a block; and
dwell—fraction of “static motion” samples per total samples in a block, where “static motion” is defined as samples that formerly had motion, but are temporarily stopped.

In operation S520, as discussed in more detail below with reference to FIG. 6, the learning apparatus 100 may update a trend R(i) associated with the time i.

The learning apparatus 100 may update the trend R(i) by, for example, averaging the parallel samples p(i), 0<i<N′ over time since the system started capturing parallel samples p(i), 0<i<N′, and the augmented sample S′(i)

In operation S530, the learning apparatus 100 may calculate a mathematical relationship between the value of the parallel sample p(i) and the corresponding value of the trend R(i), where the trend R(i) may correspond to the parallel sample p(i) and parallel samples P(i) at intervals D preceding this time i, that is, p(i)=s(i−nD), 0<i<N0, 1<n<N0.

For example, the learning apparatus 100 may calculate a difference between the value of the parallel sample p(i) and the corresponding value of the trend R(i).

In operation S540, the learning apparatus 100 may store the updated trend R(i). For example, the learning apparatus 100 may store the updated trend R(i) in the memory 320. In some example embodiments, the learning apparatus 100 may perform operations S530 and S540 in parallel or sequentially in various orders.

In operation S550, the learning apparatus 100 may determine if the mathematical relationship between the value of the parallel sample p(i) and the updated value of the trend R(i) meets given criteria.

For example, the learning apparatus 100 may determine if the difference between the value of the parallel sample p(i) and the value of the trend R(i) exceeds a threshold. The learning apparatus 100 may determine the threshold based upon the value of the trend R(i) and the statistical variance of the parallel samples P, upon which the trend R(i) is determined. Alternatively, the threshold may be a design parameter set based on empirical study. While in some example embodiments, the learning apparatus 100 may determine if the difference exceeds the threshold, example embodiments are not limited thereto. For example, in some example embodiments, the learning apparatus 100 may determine if the difference is less than a threshold, or may determine if the difference is within an interval defined by a lower and upper threshold.

If, in operation S550, the learning apparatus 100 determines that the mathematical relationship does not meet the criteria, the learning apparatus may return to operation S510 and calculate the feature for the next parallel sample p(i−(n+1)D). Alternatively, if the learning apparatus 100 determines that the mathematical relationship meets the criteria, the learning apparatus may proceed to operation S560. However, example embodiments are not limited thereto. For example, in some example embodiments, depending on the nature of the criteria, the learning apparatus 100 may proceed back to operation S510 if the mathematical relationship meets the criteria and proceed to operation S560, if the mathematical relationship does not meet the criteria.

In operation S560, if the learning apparatus 100 determines, in operation S540, that the mathematical relationship exceeds the threshold, the learning apparatus 100 may perform an action.

For example, the action performed by the learning apparatus 100 may be to generate an alert, send a message to a human operator and/or send a command to another machine (machine-to-machine), etc. Further, the action performed by the learning apparatus 100 may be to increase the sample rate of the input sample such as to, for instance, obtain a higher resolution video of the subject who caused the alert to, for example, perform face recognition on the subject. Further still, the action performed by the learning apparatus 100 may be to increase the level of air conditioning if the learning apparatus 100 determines that an excessive number of people creating body heat are present, and, thus, by anticipating this, the learning apparatus 100 may keep the room temperature at a level appropriate for the number of people.

FIG. 6 illustrates a flowchart of an operation of updating a trend by a learning apparatus according to an example embodiment.

Referring to FIGS. 5 and 6, operation S520, illustrated in FIG. 5, of updating the trend may include operations S610 to S650, illustrated in FIG. 6.

In operation S610, the learning apparatus 100 may determine whether the number of samples N′ sampled by the learning system 100 is sufficient to use the parallel sample p(i) directly to update the trend R(i), or if the number of samples N′ is insufficient to directly utilize the parallel sample p(i) and satisfy a chosen statistical confidence level because, for, example, the learning apparatus 100 is currently in a startup period and has yet to capture enough parallel samples P(i).

For example, the learning apparatus 100 may compare the number of parallel samples N′ stored in, for example, the memory 320 with a threshold. The threshold may be the minimum sample size N, and the learning system 100 may determine the minimum sample size N based on the trend R(i) and a multiple of the standard deviation d of the previously obtained parallel samples P(i). Alternatively, the threshold may be a design parameter set based on empirical study.

If, in operation S610, the learning apparatus 100 determines that the number of parallel samples N′ sampled by the learning system 100 is less than the threshold, for example, because the learning apparatus 100 is in the startup period, the learning apparatus 100 may proceed to operation S620, discussed infra.

In contrast, if, in operation S610, the learning system 100 determines that the system 1 that the number of parallel samples N′ sampled by the learning system 100 is greater than or equal to threshold, the learning apparatus 100 may proceed to operation S640, discussed infra.

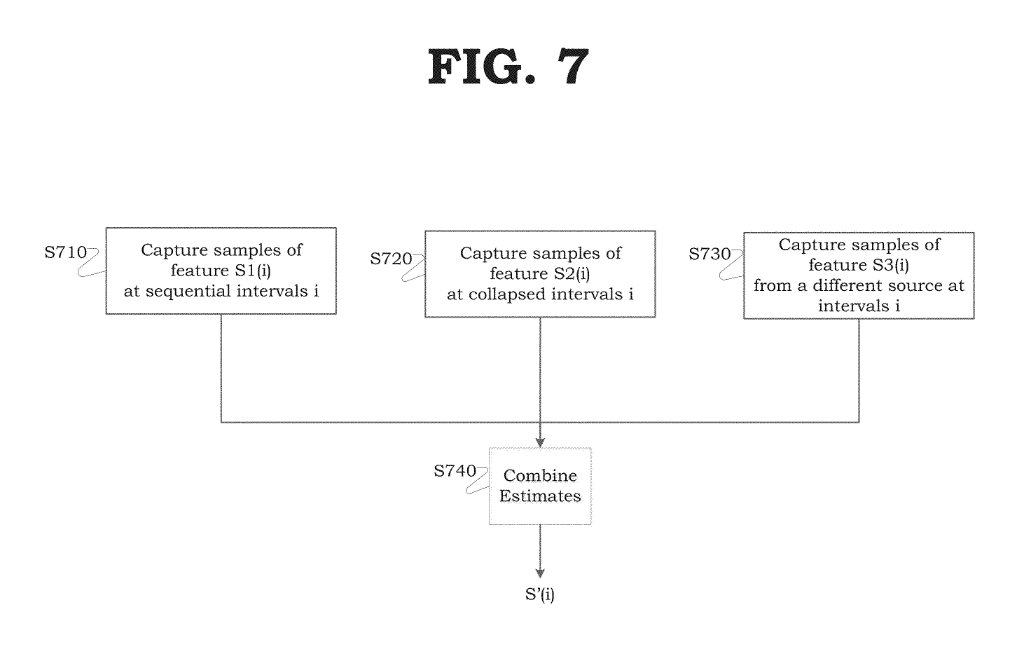

In operation S620, as discussed in more detail below with reference to FIG. 7, if the learning apparatus 100 determines in operation S610 that the number of parallel samples N′ sampled by the learning system 100 is insufficient, the learning apparatus 100 may supplement the parallel samples p(i) by capturing augmented samples S′(i), and combining the values of these augmented samples S′(i) with the parallel sample P(i).

FIG. 7 illustrates a flowchart of an operation of capturing and combining augmented samples according to example embodiments.

Referring to FIGS. 6 and 7, operation S620, illustrated in FIG. 6, of capturing augmented samples S′(i) at time i may include operations S710 to S740, illustrated in FIG. 7.

As discussed in detail below, in operations S710 to S730, the learning apparatus 100 may capture samples of a sequential feature S1(i), a collapsed feature S2(i), and a multi-source feature S3(i), respectively, and combine the same in operation S740 to generate the augmented sample S′(i). The learning apparatus 100 may perform operations S710 to S730 in parallel or sequentially in various orders.

The samples of the sequential feature S1(i) may be samples immediately prior to the parallel sample p(i), the samples of collapsed feature S2(i) may be samples obtained by grouping different samples s(i) into coarser groups, thus increasing the number of samples in each group, and the samples of the multi-source feature S3(i) may be samples s(i) associated with different ones of the source devices 110 from the source device 110 associated the parallel sample p(i).

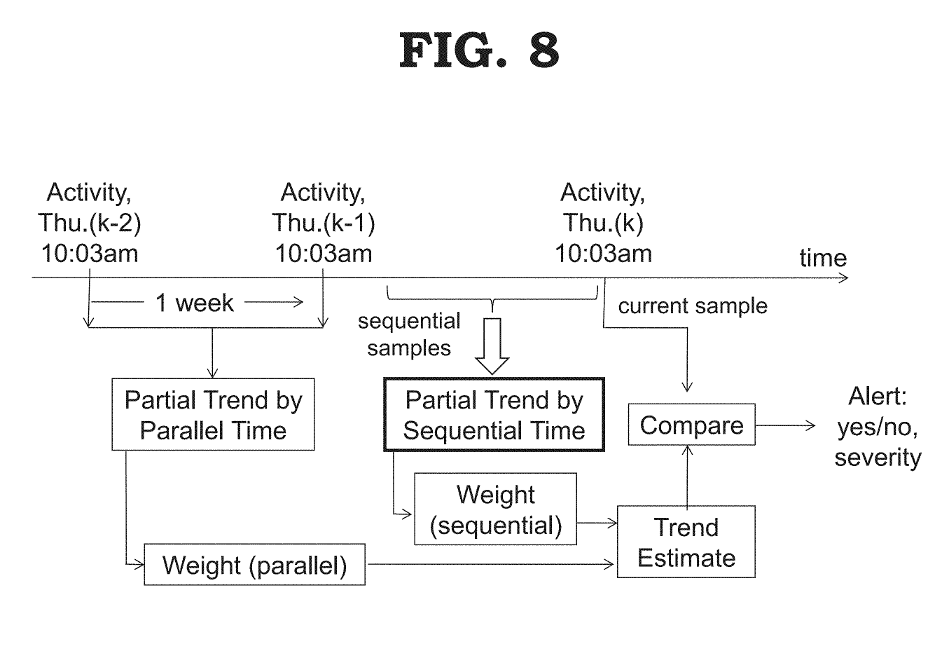

Examples of the sequential feature S1(i), the collapsed feature S2(i), and the multi-source feature S3(i) are illustrated in FIGS. 8-10, respectively, discussed below.

In operation S710, the learning apparatus 100 may augment the parallel sample p(i) with the samples S1(i) of the sequential feature.

For example, the learning apparatus 100 may compare activity of the parallel sample p(i) with the trend R(i) of activity at multiple sample points in the past taken at regular intervals nD, where 1<n<N0. The estimate of these past parallel samples may be represented by Equation 3:

P(i)=f(p(i))=f(s(i−nD)),1<n<N0 Eq. 3

In Equation 3, f(*) may be a function that performs an operation on the parallel sample p(i). Examples of the function f(*) are a function that finds the average value of the parallel samples, and a function that finds the maximum value of the parallel samples p(i).

The learning apparatus may compare the past parallel samples P(i) determined in Equation 3, to the current trend R(i) using Equation 4:

P(i)?R(i),1<n<N0 Eq. 4

In Equation 4, “?” is an operator, examples which might be “>”, “<”, “=”, etc. If the result of the operator ? is true, then the learning apparatus 100 may perform an action, and if not, the learning apparatus 100 may not perform the action.

In Equations 3 and 4, N0 may be the chosen number of data samples, where this value may be chosen to be above the value N in Equation 1, which is used for a chosen level of statistical confidence. The interval D may be the parallel time interval at which we expect activity to have similar characteristics, such as an hour, a day, a week, a month, etc. For example, D may be chosen to be hourly if classes in a school begin and end on an hourly interval. D may be chosen to be daily if, for example, traffic conditions are similar on a day-to-day basis. D may be chosen to be 7 days if, for example, customer traffic at a retail store is has different characteristics for each day of the week.

Therefore, during the startup period, when a relatively small number of the parallel samples P(i) have been collected, the learning apparatus 100 may augment the sparse parallel samples P(i) with the sequential sample S1(i) estimate of the feature in an attempt to collect N0 samples of the feature in total.

In operation S720, the learning apparatus 100 may collect collapsed time samples S2(i) of the feature by grouping together the samples s(i) into coarser groups, thus increasing the number of samples in each group.

For example, the samples s(i) may be grouped into one of seven discrete days of the week, and the learning apparatus 100 may re-group the samples such that samples associated with Monday to Friday are collapsed into a weekday group, and samples associated with Saturday and samples associated with Sunday are collapsed into a weekend group. Therefore, if there is at least one sample for each of the days of the week, the weekday group of samples may have five times (5×) the number of samples in each of the groups associated with one of the seven discrete days of the week.

In operation S730, the learning apparatus 100 may collect multi-source samples S3(i) from one or more source devices 110 by grouping together samples associated with one or more of the source devices 110 different from the source device 110 associated with the parallel sample p(i).

For example, there may be similar activity among many of the different source devices 110, especially among ones of the source devices 110 that capture overlapping and adjacent views. Therefore, the learning apparatus 100 may group ones of the source devices 110 that are set to capture views that overlap and/or are adjacent together in a same group. Therefore, the learning apparatus 100 may increase the number of samples in each group, if there are at least two source devices 110 that are set to capture overlapping, adjacent, or close by views.

In operation S740, the learning apparatus 100 may combine the estimate samples S1(i) to S3(i) of the feature generated in operations S610 to S630.

For example, the learning apparatus 100 may combine the estimate samples S1(i) to S3(i) to generate the augmented sample S(i) based on Equation 5:

S(i)=w1*S1(i)+w2*S2(i)+w3*S3(i) Eq. 5

In Equation 5, S1(i) may represent the sample estimate of the sequential feature values associated with time i, S2(i) may represent estimate of the collapsed feature values associated with time i, and S3(i) may represent estimate of the multi-source feature values associated with time i.

The augmented sample S(i) may be utilized to increase the number of samples because the augmented sample S(i) is captured under similar conditions to that of the parallel sample p(i), and can thus act as a good estimate of the parallel value p(i). Furthermore, the weighted combination of estimated values {S1, S2, S3} in Equation 5 is also a good estimate of the parallel sample p(i), and may represent a better estimate versus any of the individual estimates, S1(i), S2(i), or S3(i).

Parameters w1 to w3, may represent the weights given to the samples of the sequential feature S1, the collapsed feature S2, and the multi-source feature S3.

The learning apparatus 100 may determine the weights w1 to w3 in various ways. For example, the learning apparatus 100 may assign a same value to each of the weights w1 to w3. Alternatively, in other example embodiments, the learning apparatus 100 may empirically set the weights based on, for example, the relative influence of different trend estimates, S(i). For example, if the learning apparatus 100 determines that most days have similar activity, the learning apparatus 100 may assign a relatively greater weight to the estimates of the collapsed feature S2(i). Alternatively, if the learning apparatus 100 determines that the source devices 110 have a large degree of overlap, and, thus the data generated therefrom is strongly correlated, the learning apparatus 100 may assign relatively greater weight to the samples of the multi-source estimate S3(i). Alternatively still, if the learning apparatus 100 determines that the estimates of the collapsed feature S2(i) and the multi-source estimate S3(i) are close to the true trend R(i), the learning apparatus 100 may assign relatively greater weight to the samples of the sequential feature S1(i).

Referring back to FIG. 6, in operation S630, the learning apparatus 100 may perform accelerated learning by updating the trend R(i) based on a combination of parallel sample p(i) and the augmented estimates S(i), which include the sequential estimates S1(i).

For example, the learning apparatus 100 may utilize Equation 6 to perform accelerated learning of the trend R(i) based on the parallel samples P(i) that have already been captured and the augmented estimate S(i).

R(i)=f(p(i),S(i)) Eq. 6

In Equation 6, the function f(*) indicates that R(i) is calculated upon the combination of parallel sample p(i) and augmented sample S(i) estimate, and this function is explained below.

The learning apparatus 100 may perform accelerated learning of the trend R(i) based on the augmented sample S(i) and parallel sample p(i) during a hybrid transition period, in which the learning apparatus 100 captures additional parallel samples p(i) over time.

For example, during the hybrid transition period, even when a small amount of parallel samples P(i) are available, the learning apparatus 100 may not directly cutover from only utilizing the parallel samples P(i) because the value of an individual parallel sample p(i) may be affected by noise. Therefore, until more samples are obtained (NO to achieve statistical confidence), the learning apparatus 100 utilizes the function f(*) to determine the trend R(i) using a combination of parallel sample p(i) and augmented sample S(i) estimates.

For example, if anomalies are rare, occur in a burst of 2 samples, and have a deviation 1.3 times that of non-anomalous data, to average this such that the result is maximum 5% above non-anomalous data, the learning apparatus 100 may implement Equation 7:

(2*1.3+(n−2)*1)/n=1.05 Eq. 7
n=12 samples.

For parallel time, this would require a combination of true trend plus estimated trend over 12 parallel time samples. After this transition period, trend samples would no longer be a combination, but just the true parallel samples, so this constitutes the ending criterion for the hybrid transition period.

As parallel data estimates Np are obtained during the transition period, these are replaced for sequential data estimates Ns until the sum of these is equal to the N required for statistical confidence. That is:

Ns=N−Np Eq. 8

The stopping criterion for the transition period is evident here as:

Np=N Eq. 9

As shown in Equation 8, when Np equals N, the learning apparatus 100 may determine that the hybrid transition period is over and, as discussed below, proceed to calculate the trend R(i) based only on parallel samples based on Equation 10:

R(i)=f(p(i)). Eq. 10

For example, f(*) may be an arithmetic mean expressed using Equation 11:

R(i)=sum(p(i))/N,i=0, . . . ,N Eq. 11

As discussed above, if, in operation S610, the learning system 100 determines that the system 1 has the sufficient number N of parallel samples P, for example, because the start-up period has finished, the learning apparatus 100 may proceed to operation S640.

At the end of the hybrid transition period, the learning apparatus 100 may switch to operating in a normal learning mode rather than the accelerated learning mode. However, at the end of the hybrid transition period, the learning apparatus 100 may be estimating the trend R(i), in operation S630, using Equation 11, such that the trend R(i) is based upon the arithmetic mean of the parallel samples p(i). Thus, if the learning apparatus 100 were to continue to utilize the arithmetic mean, the learning apparatus 100 may give weight to old data, which may be undesirable.

Therefore, in operation S640, the learning apparatus 100 may determine if the learning apparatus 100 is in an averaging transition period, during which, the learning apparatus 100 has more than N parallel samples p(i), and determines the trend R(i) by combining the parallel samples p(i) such that the combination operation transitions from combining the parallel samples p(i) using the arithmetic mean to combining the parallel samples p(i) using a moving average.

More specifically, as discussed above, at the end of the hybrid updating period, the learning apparatus 100 may be calculating the trend R(i) using Equation 9.

Thereafter, in operation S650, the learning apparatus 100 may enter an during the averaging transition period, and calculate the trend R(i) based on Equation 12:

R(i)=T′*p(i)+(1−T′)*R(i−1),i=0,1,2, Eq. 12

In Equation 12, R(i) is the trend R(i) at time sample i, p(i) is the parallel sample at time i, R(i−1) is moving average result at time i−1, and T′ is time constant that is dependent upon time i.

The process is initialized as shown below in Equation 13, such that the initial time constant T′1 is equal to the first sample.

T′=1,R(i=0)=T′*p(0)+(1−T′)*R(−1)=p(t) Eq. 13

For subsequent samples, the learning apparatus 100 may reduce the time constant T′ using Eq. 14 to gradually transition toward a moving average filter of the chosen T value.

T′(i)={1,½,⅔,¾, . . . ,i/(i+1)} Eq. 14

At the end of the averaging transition period, T′ may be equal to T, such that at the next iteration, the learning apparatus 100 may determine, in operation S640, that the T′<=T, and thus, the averaging transition period is complete, and no further transitioning may be performed.

Thereafter, in operation S660, the learning apparatus 100 may determine the trend R(i) using strictly a moving average based on Equation 16:

R(i)=T*p(i)+(1−T)*R(i−1),i=0,1,2, Eq. 16

In Equation 16, R(i), p(i), and R(i−1) are the same variables discussed above in regards to Equation 13, while T is time constant, 0<T<1.0.

As discussed above, by transitioning from an arithmetic mean to a moving average, the learning apparatus 100 may calculate the trend R(i) as close to the moving average of time constant T as the number N′ of parallel samples p(i) allows. Further, the learning apparatus 100 may transition toward use of the desired time constant T relatively quickly.

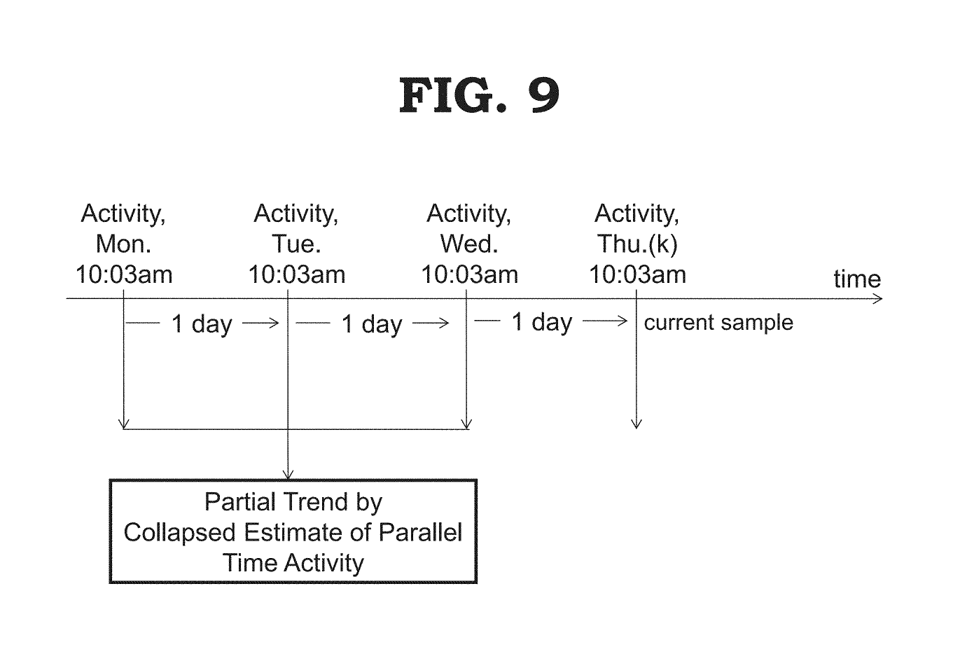

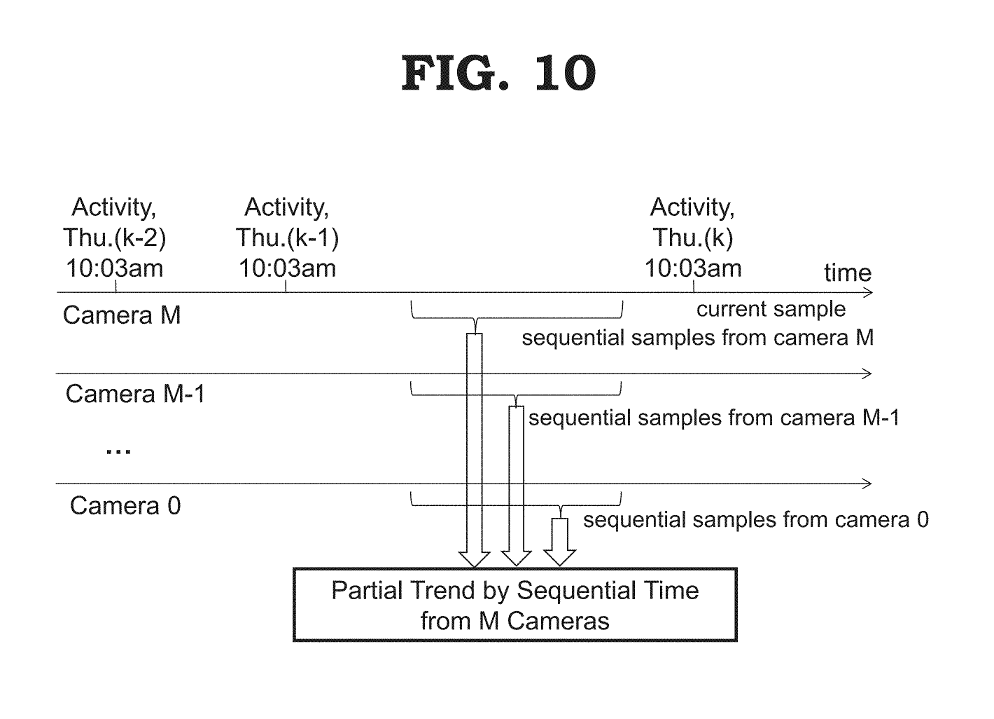

FIG. 8 illustrates an example of utilizing sequential time samples to augment parallel samples according to example embodiments. FIG. 9 illustrates an example of utilizing collapsed time samples to augment parallel samples according to example embodiments. FIG. 10 illustrates an example of utilizing multi-view time samples to augment parallel samples according to example embodiments.

Referring to FIG. 8, the learning apparatus 100 may use sequential time samples S1(i) to accelerate learning and alerting, while parallel samples p(i) are collected and incorporated into the trend R(i) as they become available. As illustrated, the learning apparatus 100 weights the sequential time samples and the parallel samples p(i) based on the number of samples that has been collected such that the learning apparatus 100 gives greater weight to the parallel samples p(i) as the number of samples increases.

Referring to FIG. 9, instead of, for example, distinguishing Monday from Tuesday, from Wednesday, etc., the learning apparatus 100 may collapse all weekdays into a single designated group as the samples of the collapsed feature S2(i). Therefore, the learning apparatus 100 may obtain 5 weekday samples per week (at equal times-of-day) instead of a single sample per week for each weekday. Therefore, the learning apparatus 100 may increase the number of samples for the weekday trend estimate by 5×.

Referring to FIG. 10, instead of collecting parallel samples p(i) from a single one of the source device 110 at fixed intervals, the learning apparatus 100 may capture parallel samples of the feature at the same fixed interval D from different ones of the source devices 110 as samples of multi-source feature S3(i). For example, the learning apparatus 100 may capture samples from cameras 0 to M at the interval D as the multi-source feature s3′(i).

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

We claim:

1. A learning apparatus comprising:
a processor configured to,
capture one or more parallel samples of a feature, the one or more parallel samples being samples captured at a regular interval,
selectively perform accelerated learning of a trend based on a number of the one or more parallel samples, and
analyze a latest parallel sample of the one or more parallel samples based on the trend.

2. The learning apparatus of claim 1, wherein the processor is configured to selectively perform the accelerated learning by,
determining whether the learning apparatus is operating in an accelerated learning state or a normal learning state based on the number of the one or more parallel samples and a threshold, and
if the learning apparatus is operating in the accelerated learning state,
capturing one or more augmented samples related to the latest parallel sample, and
updating the trend based on a set of samples from the one or more augmented samples and the one or more parallel samples.

3. The learning apparatus of claim 2, wherein the processor is configured to determine the threshold based on the trend and a statistical variance of the one or more parallel samples.

4. The learning apparatus of claim 2, wherein the processor is configured to determine whether the learning apparatus is in a transition period based on whether a transition time constant and a desired time constant converge, if the learning apparatus is operating in the normal learning state.

5. The learning apparatus of claim 4, wherein the processor is configured to,
update the trend by transitioning from an arithmetic mean of the set of samples to a moving average of the set of samples based on the transition time constant, if the learning apparatus is in the transition period, and
update the trend based on a moving average of the one or more parallel samples, if the learning apparatus has completed the transition period.

6. The learning apparatus of claim 1, wherein the processor is further configured to capture the one or more parallel samples from a first source device such that the one or more parallel samples are obtained at multiples of the interval.

7. The learning apparatus of claim 6, wherein the processor is further configured to capture the one or more augmented samples by,
capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.

8. The learning apparatus of claim 1, wherein the processor is configured to analyze the latest parallel sample by determining whether a mathematical relationship between the latest parallel sample and the trend meets a criteria.

9. The learning apparatus of claim 1, wherein the processor is further configured to selectively perform an action, if the mathematical relationship meets the criteria.

10. A method of operating a learning apparatus, the method comprising:
capturing one or more parallel samples of a feature, the one or more parallel samples being samples captured at a regular interval;
selectively performing accelerated learning of a trend based on a number of the one or more parallel samples; and
analyzing a latest parallel sample of the one or more parallel samples based on the trend.

11. The method claim 10, wherein the selectively performing accelerated learning comprises:
determining whether the learning apparatus is operating in an accelerated learning state or a normal learning state based on the number of the one or more parallel samples and a threshold; and
if the learning apparatus is operating in the accelerated learning state,
capturing one or more augmented samples related to the latest parallel sample, and
updating the trend based on a set of samples from the one or more augmented samples and the one or more parallel samples.

12. The method claim 11, further comprising:
determining the threshold based on the trend and a statistical variance of the one or more parallel samples.

13. The method claim 11, further comprising:
determining whether the learning apparatus is in a transition period based on whether a transition time constant and a desired time constant converge, if the learning apparatus is operating in the normal learning state;
updating the trend by transitioning from an arithmetic mean of the set of samples to a moving average of the set of samples based on the transition time constant, if the learning apparatus is in the transition period; and
updating the trend based on a moving average of the one or more parallel samples, if the learning apparatus has completed the transition period.

14. The method claim 11, wherein
the capturing the one or more parallel samples captures the one or more parallel samples from a first source device such that the one or more parallel samples are obtained at multiples of the interval, and
the capturing one or more augmented samples includes capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.

15. The method claim 11, wherein the analyzing includes determining whether a mathematical relationship between the latest parallel sample and the trend meets a criteria, and the method further comprises:
selectively performing an action, if the mathematical relationship meets the criteria.

16. A non-transitory computer readable medium storing instructions that, when executed by a processor, configure the processor to,
capture one or more parallel samples of a feature, the one or more parallel samples being samples captured at a regular interval;
selectively perform accelerated learning of a trend based on a number of the one or more parallel samples; and
analyze a latest parallel sample of the one or more parallel samples based on the trend.

17. The non-transitory computer readable medium 16, wherein the instructions, when executed, configure the processor to selectively perform accelerated learning by,
determining whether the learning apparatus is operating in an accelerated learning state or a normal learning state based on the number of the one or more parallel samples and a threshold; and
if the learning apparatus is operating in the accelerated learning state,
capturing one or more augmented samples related to the latest parallel sample, and
updating the trend based on a set of samples from the one or more augmented samples and the one or more parallel samples.

18. The non-transitory computer readable medium 17, wherein the instructions, when executed, configure the processor to,
determine the threshold based on the trend and a statistical variance of the one or more parallel samples.

19. The non-transitory computer readable medium 17, wherein the instructions, when executed, configure the processor to,
determine whether the learning apparatus is in a transition period based on whether a transition time constant and a desired time constant coverage, if the learning apparatus is operating in the normal learning state,
update the trend by transitioning from an arithmetic mean of the set of samples to a moving average of the set of samples based on the transition time constant, if the learning apparatus is in the transition period, and
update the trend based on a moving average of the one or more parallel samples, if the learning apparatus has completed the transition period.

20. The non-transitory computer readable medium 17, wherein the instructions, when executed, configure the processor to,
capture the one or more parallel samples from a first source device such that the one or more parallel samples are obtained at multiples of the interval, and
capture the one or more augmented samples by capturing one or more of sequential samples, collapsed samples, and multi-source samples of the feature, the sequential samples being samples of the feature occurring prior to a latest instance of the interval, the collapsed sample being samples obtained by combining samples at the interval with samples collected at a different interval, and the multi-source samples being samples associated with a second source device obtained at the multiples of the interval.
